(19) United States
(12) Patent Application Publication
(10) Pub. No.: US 2023/0343510 A1
(43) Pub. Date: Oct. 26, 2023

(54) COIL COMPONENT

(71) Applicant: SAMSUNG ELECTRO-MECHANICS CO., LTD., Suwon-si (KR)

(72) Inventor: Jin Hyuk JANG, Suwon-si (KR)

(73) Assignee: SAMSUNG ELECTRO-MECHANICS CO., LTD., Suwon-si (KR)

(21) Appl. No.: 18/071,157

(22) Filed: Nov. 29, 2022

(30) Foreign Application Priority Data
Apr. 25, 2022 (KR) 10-2022-0050680

(51) Int. Cl. H01F 27/32; H01F 27/29

(52) U.S. Cl. CPC H01F 27/32; H01F 27/29; H01F 2027/065

(57) ABSTRACT

A coil component includes a body having one surface and the other surface facing each other, and a plurality of side surfaces connecting the one surface and the other surface to each other, a substrate disposed in the body, a coil portion including first and second coil patterns disposed on one surface of the substrate and each having at least one turn, and third and fourth coil patterns disposed on the other surface of the substrate and each having at least one turn, and first and second external electrodes disposed to be spaced apart from each other on the one surface of the body, respectively connected to the second and fourth coil patterns, and respectively spaced apart from the side surfaces of the body. Winding axes of the first to fourth coil patterns are parallel to the one surface of the body.

### CROSS-REFERENCE TO RELATED APPLICATION(S)

This application claims benefit of priority to Korean Patent Application No. 10-2022-0050680 filed on Apr. 25, 2022 in the Korean Intellectual Property Office, the disclosure of which is incorporated herein by reference in its entirety.

### TECHNICAL FIELD

The present disclosure relates to a coil component.

An inductor, a coil component, is a representative passive electronic component used together with a resistor and a capacitor in electronic devices.

As electronic devices become increasingly high-performance and thin, coil components are also becoming increasingly thin (low-profile).

There is demand for a coil component having a vertical coil structure with characteristics such as high capacity and high efficiency while using a miniaturized and thinned coil component.

Related Art 1: Korean Patent Application Publication No. 10-2018-0071644

### SUMMARY

An aspect of the present disclosure is to provide a coil component capable of achieving high capacity with a multilayer structure while being thinned (low-profile).

Another aspect of the present disclosure is to increase a degree of freedom in designing a coil component by implementing a vertical coil to have a multilayer structure.

Another aspect of the present disclosure is to provide a coil component advantageous for integration in the same mounting area by forming a distance between adjacent coil components to be closer when mounted on a printed circuit board (PCB).

According to an aspect of the present disclosure, a coil component includes a body having one surface and the other surface facing each other, and a plurality of side surfaces connecting the one surface and the other surface to each other, a substrate disposed in the body, a coil portion including first and second coil patterns disposed on one surface of the substrate and each having at least one turn, and third and fourth coil patterns disposed on the other surface of the substrate and each having at least one turn, and first and second external electrodes disposed on the one surface of the body, spaced apart from each other and from the side surfaces of the body, and connected to the second and fourth coil patterns, respectively. Winding axes of the first to fourth coil patterns are parallel to the one surface of the body.

According to an aspect of the present disclosure, a coil component includes a body having one surface, and one end surface and the other end surface connected to the one surface and facing each other, a substrate disposed in the body, a coil portion including first and second coil patterns disposed on one surface of the substrate and each having at least one turn, third and fourth coil patterns disposed on the other surface of the substrate and each having at least one turn, and first and second lead-out portions in contact with the one end surface and the other end surface of the body, respectively, and spaced apart from the one surface of the body, and first and second external electrodes disposed on the one end surface and the other end surface of the body, respectively, to be connected to the first and second lead-out portions, respectively. Winding axes of the first to fourth coil patterns are parallel to the one surface of the body.

According to an aspect of the present disclosure, a high-capacity characteristic of a coil component may be achieved by an increase in the number of turns caused by a multilayer structure while thinning the coil component to be low-profile.

According to another aspect of the present disclosure, a vertical coil may be implemented to have a multilayer structure, thereby increasing a degree of freedom in designing a coil component.

According to another aspect of the present disclosure, it is possible to make a distance between adjacent coil components closer when mounted on a PCB, thereby providing a coil component advantageous for integration in the same mounting area.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first example embodiment of the present disclosure;

FIG. 2, an exploded perspective view of FIG. 1, illustrates a connection relationship of a coil portion;

FIG. 3 is a view illustrating a cross-section taken along line I-I′ of FIG. 1;

FIG. 4 is a bottom view of FIG. 1;

FIG. 5 is a view illustrating a cross-section taken along line II-II′ of FIG. 1.

FIG. 6 is a perspective view schematically illustrating a coil component according to a second example embodiment of the present disclosure;

FIG. 7, an exploded perspective view of FIG. 6, illustrates a connection relationship of a coil portion;

FIG. 8, a cross-sectional view of a coil component according to a third example embodiment of the present disclosure, corresponds to FIG. 3;

FIG. 9 is a perspective view schematically illustrating a coil component according to a fourth example embodiment of the present disclosure;

FIG. 10 is a view illustrating a cross-section taken along line III-III′ of FIG. 9; and

FIG. 11 is a view illustrating a cross-section taken along line IV-IV′ of FIG. 9.

### DETAILED DESCRIPTION

The terms used in the description of the present disclosure are used to describe a specific example embodiment, and are not intended to limit the present disclosure. A singular term includes a plural form unless otherwise indicated. The terms “include,” “comprise,” “is configured to,” and the like of the description of the present disclosure are used to indicate the presence of features, numbers, steps, operations, elements, parts, or combination thereof, and do not exclude the possibilities of combination or addition of one or more additional features, numbers, steps, operations, elements, parts, or combination thereof. In addition, the terms “disposed on,” “positioned on,” and the like, may indicate that an element is positioned on or beneath an object, and does not necessarily mean that the element is positioned above the object with respect to a gravity direction.

The term “coupled to,” “combined to,” and the like, may not only indicate that elements are directly and physically in contact with each other, but also include a configuration in which another element is interposed between the elements such that the elements are also in contact with the other component.

Sizes and thicknesses of respective elements illustrated in the drawings are indicated as examples for ease of description, and the present disclosure are not limited thereto.

In the drawings, an L direction may be defined as a first direction or a length direction, a W direction may be defined as a second direction or a width direction, and a T direction may be defined as a third direction or a thickness direction.

Hereinafter, a coil component according to an example embodiment of the present disclosure is described in detail with reference to the accompanying drawings. Referring to the accompanying drawings, the same or corresponding components may be denoted by the same reference numerals, and a repeated description is omitted.

In electronic devices, various types of electronic components may be used, and various types of coil components may be properly used between the electronic components to remove noise, or for other purposes.

That is, in electronic devices, a coil component may be used as a power inductor, a high frequency (HF) inductor, a general bead, a high frequency (GHz) bead, a common mode filter, and the like.

### First Example Embodiment

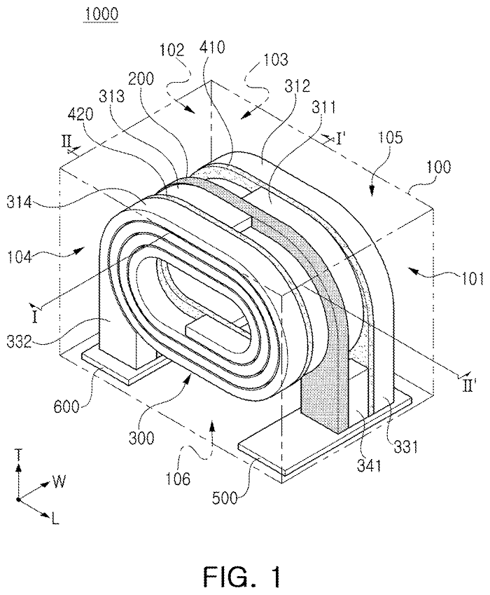

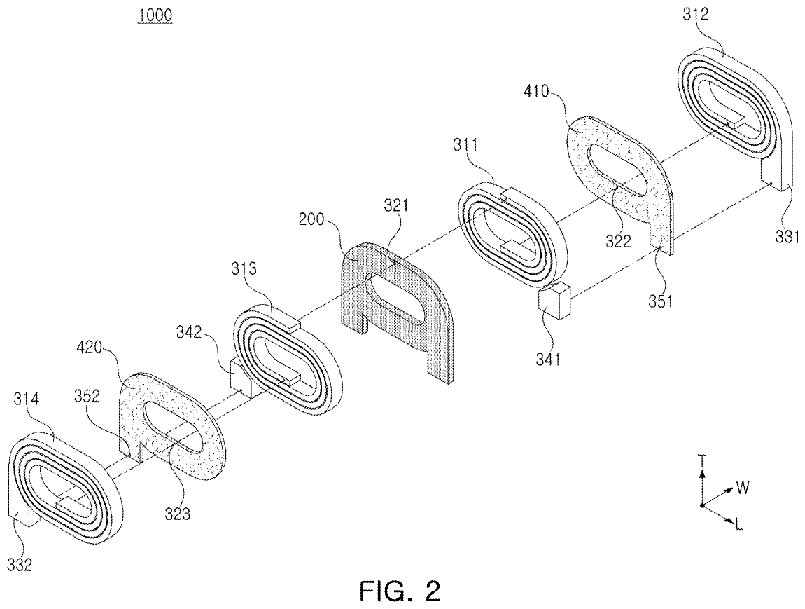

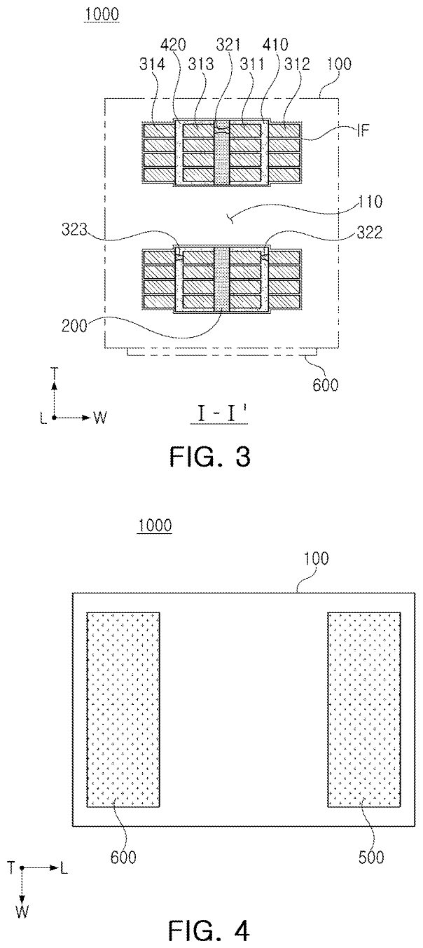

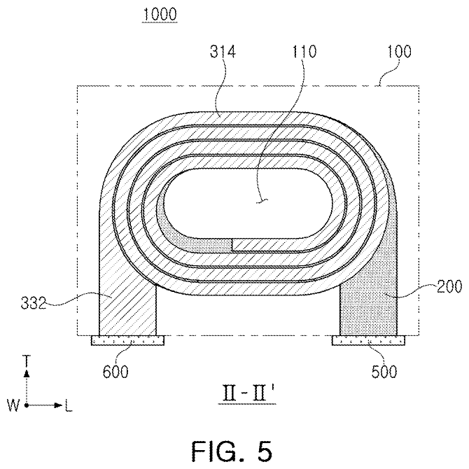

FIG. 1 is a perspective view schematically illustrating a coil component according to a first example embodiment of the present disclosure. FIG. 2, an exploded perspective view of FIG. 1, illustrates a connection relationship of a coil portion. FIG. 3 is a view illustrating a cross-section taken along line I-I′ of FIG. 1. FIG. 4 is a bottom view of FIG. 1. FIG. 5 is a view illustrating a cross-section taken along line II-II′ of FIG. 1.

Referring to FIGS. 1 to 5, the coil component 1000 according to the present example embodiment may include a body 100, a substrate 200, a coil portion 300 having a plurality of coil patterns 311, 312, 313, and 314, and external electrodes 500 and 600, and may further include insulating layers 410 and 420 disposed between the coil patterns.

The body 100 may form an overall exterior of the coil component 1000 according to the present example embodiment, and the substrate 200 and the coil portion 300 may be embedded therein.

The body 100 may be formed to have an overall hexahedral shape.

Referring to FIG. 1, the body 100 may include a first surface 101 and a second surface 102 facing each other in a longitudinal direction L, and a third surface 103 and a fourth surface 104 facing each other in a width direction W, and a fifth surface 105 and a sixth surface 106 facing each other in a thickness direction T. Each of the first to fourth surfaces 101, 102, 103 and 104 of the body 100 may correspond to wall surfaces of the body 100 connecting the fifth surface 105 and the sixth surface 106 of the body 100. Hereinafter, opposite end surfaces of the body 100 may refer to the first surface 101 and the second surface 102 of the body 100, opposite side surfaces of the body 100 may refer to the third surface 103 and the fourth surface 104 of the body 100, one surface of the body 100 may refer to the sixth surface 106 of the body 100, and the other surface of the body 100 may refer to the fifth surface 105 of the body 100. In addition, hereinafter, an upper surface and a lower surface of the body 100 may refer to the fifth surface 105 and the sixth surface 106 of the body 100, respectively, determined based on the direction of FIG. 1.

The body 100 may be formed so that the coil component 1000 according to the present example embodiment in which external electrodes 500 and 600 to be described below are formed may be formed to have, for example, a length of 0.8 mm, a width of 0.4 mm, and a thickness of 0.8 mm, a length of 0.8 mm, a width of 0.4 mm, and a thickness of 0.65 mm, a length of 1.0 mm, a width of 0.7 mm, and a thickness of 0.8 mm, a length of 1.0 mm, a width of 0.6 mm, and a thickness of 0.8 mm, a length of 1.0 mm, a width of 0.5 mm, and a thickness of 0.8 mm, a length of 1.0 mm, a width of 0.5 mm, and a thickness of 0.65 mm, or a length of 1.0 mm, a width of 0.5 mm, and a thickness of 0.6 mm, but is not limited thereto. The above-described exemplary numerical values for the length, width, and thickness of the coil component 1000 may refer to numerical values that do not reflect a process error, and thus it should be understood that numerical values in a range that is recognizable as a process error are the above-described exemplary numerical values.

The length of the above-described coil component 1000 may refer to, based on an optical microscope image or scanning electron microscope (SEM) image of a cross-section in a longitudinal direction L-thickness direction T taken from a central portion in a width direction W of the coil component 1000, a maximum value among dimensions of a plurality of line segments connecting two outermost boundary lines facing to each other in a longitudinal direction L of the coil component 1000 illustrated in the image to be parallel to the longitudinal direction L, and spaced apart from each other in a thickness direction T. Alternatively, the length of the coil component 1000 may refer to a minimum value among the dimensions of the plurality of line segments described above. Alternatively, the length of the coil component 1000 may refer to an arithmetic mean value of at least three of the dimensions of the plurality of line segments described above. Here, the plurality of line segments parallel to the longitudinal direction L may be equally spaced apart from each other in the thickness direction T, but the scope of the present disclosure is not limited thereto.

The thickness of the above-described coil component 1000 may refer to, based on an optical microscope image or SEM image of a cross-section in a longitudinal direction L-thickness direction T taken from a central portion in a width direction W of the coil component 1000, a maximum value among dimensions of a plurality of line segments connecting two outermost boundary lines facing to each other in a thickness direction T of the coil component 1000 illustrated in the image to be parallel to the thickness direction T, and spaced apart from each other in a longitudinal direction L. Alternatively, the thickness of the coil component 1000 may refer to a minimum value among the dimensions of the plurality of line segments described above. Alternatively, the thickness of the coil component 1000 may refer to an arithmetic mean value of at least three of the dimensions of the plurality of line segments described above. Here, the plurality of line segments parallel to the thickness direction T may be equally spaced apart from each other in the longitudinal direction L, but the scope of the present disclosure is not limited thereto.

The width of the above-described coil component 1000 may refer to, based on an optical microscope image or SEM image of a cross-section in a longitudinal direction L-width direction W taken from a central portion in a thickness direction T of the coil component 1000, a maximum value among dimensions of a plurality of line segments connecting two outermost boundary lines facing to each other in a width direction T of the coil component 1000 illustrated in the image to be parallel to the width direction W, and spaced apart from each other in a longitudinal direction L. Alternatively, the width of the coil component 1000 may refer to a minimum value among the dimensions of the plurality of line segments described above. Alternatively, the width of the coil component 1000 may refer to an arithmetic mean value of at least three of the dimensions of the plurality of line segments described above. Here, the plurality of line segments parallel to the width direction W may be equally spaced apart from each other in the longitudinal direction L, but the scope of the present disclosure is not limited thereto.

Alternatively, each of the length, width, and thickness of the coil component 1000 may be measured by a micrometer mensuration. According to the micrometer mensuration, measurement may be performed by setting a zero point with a gage repeatability and reproducibility (R&R) micrometer, inserting the coil component 1000 according to the present example embodiment between micrometer tips, and turning a micrometer measuring lever. In measuring the length of the coil component 1000 using the micrometer mensuration, the length of the coil component 1000 may refer to a value measured once or an arithmetic average of values measured a plurality of times, which may be equally applied to the width and thickness of the coil component 1000.

The body 100 may include a magnetic powder and an insulating resin. Specifically, the body 100 may be formed by stacking at least one composite sheet including the insulating resin and the magnetic powder dispersed in the insulating resin, and then curing the magnetic composite sheet. However, the body 100 may have a structure other than the structure in which the magnetic powder is dispersed in the insulating resin. For example, the body 100 may be made of a magnetic material such as ferrite.

The magnetic powder may be, for example, a ferrite powder or a magnetic metal powder.

The ferrite powder may include, for example, at least one of spinel type ferrites such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder.

The magnetic metal powder may be amorphous or crystalline. For example, the magnetic metal powder may be a Fe—Si—B—Cr-based amorphous alloy powder, but is not limited thereto.

The ferrite powder and the magnetic metal powder may have an average diameter of about 0.1 μm to 30 μm, respectively, but are not limited thereto.

The body 100 may include two or more types of magnetic powder particles dispersed in an insulating resin. Here, different types of magnetic powder particles may mean that magnetic powder particles dispersed in the insulating resin are distinguished from each other by one of a diameter, a composition, crystallinity, and a shape. For example, the body 100 may include two or more magnetic powder particles with different diameters. The diameter of the magnetic powder particle may refer to a diameter according to a particle size distribution represented as D₅₀ or D₉₀.

The insulating resin may include an epoxy, a polyimide, a liquid crystal polymer, and the like in a single form or in a combined form, but is not limited thereto.

The body 100 may include a core 110 passing through a substrate 200 to be described below and the coil portion 300. In a process of stacking and curing a magnetic composite sheet, the core 110 may be formed by filling through holes of the substrate 200 and the coil portion 300 with at least a portion of the magnetic composite sheet, but is not limited thereto.

One surface of the substrate 200 may be embedded in the body 100 to be perpendicular to the fifth and sixth surfaces 105 and 106 of the body 100. In some embodiments, the one surface of the substrate may face the third surface 103 of the body. The substrate 200 may be configured to support the coil portion 300 to be described below, and a plurality of coil patterns 311, 312, 313, and 314 may be disposed on one surface and the other surface of the substrate 200 facing each other. The coil portion 300 according to the present example embodiment may be disposed to be perpendicular to the fifth and sixth surfaces 105 and 106 of the body 100. That is, winding axes of the plurality of coil patterns 311, 312, 313, and 314 may be disposed in parallel with the sixth surface 106 of the body 100. Here, the winding axis may refer to an axis passing through a central portion of a spiral shape of each of the coil pattern 311, 312, 313, and 314, and may substantially refer to a central axis of the core 110.

The substrate 200 may be formed of an insulating material including a thermosetting insulating resin such as an epoxy resin, a thermoplastic insulating resin such as polyimide, or a photosensitive insulating resin, or may be formed of an insulating material in which a reinforcing material such as a glass fiber or an inorganic filler is impregnated with the insulating resin. For example, the substrate 200 may include a prepreg, Ajinomoto build-up film (ABF), FR-4, bismaleimide triazine (BT) film, photo imagable dielectric (PID), copper clad laminate (CCL), and the like, but is not limited thereto.

As the inorganic filler, at least one selected from a group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the substrate 200 is formed of an insulating material including a reinforcing material, the substrate 200 may provide more excellent rigidity. When the substrate 200 is formed of an insulating material including no glass fiber, it may be advantageous to reduce a width of a component by thinning overall thickness of the substrate 200 and the coil portion 300 (where the overall thickness refers to a sum of dimensions of the coil portion 300 and the substrate 200 in the width direction W of FIG. 1). When the substrate 200 is formed of an insulating material including a photosensitive insulating resin, the number of processes for forming the coil portion 300 may be reduced. Accordingly, this may be advantageous in reducing production costs, and a fine via may be formed. The thickness of the substrate 200 may be, for example, 10 μm or more and 50 μm or less, but is not limited thereto.

The coil portion 300 may be embedded in the body 100 to manifest characteristics of a coil component. For example, when the coil component 1000 according to the present example embodiment is used as a power inductor, the coil portion 300 may function to stabilize the power supply of an electronic device by storing an electric field as a magnetic field and maintaining an output voltage.

The coil portion 300 may include a plurality of coil patterns 311, 312, 313, and 314, vias 321, 322, and 323, and lead-out portions 331 and 332. In addition, the coil portion 300 may further include sub-lead-out portions 341 and 342. In addition, the coil portion 300 may further include sub-vias 351 and 352.

Referring to FIGS. 1 to 3, the coil portion 300 may include a plurality of coil patterns 311, 312, 313, and 314. Hereinafter, it is assumed that the coil portion 300 according to the present example embodiment includes a total of four coil patterns 311, 312, 313, and 314, but the scope of the present example embodiment is not limited thereto.

Specifically, in the coil portion 300 according to the present example embodiment, first and second coil patterns 311 and 312 may be sequentially disposed on one surface of the substrate 200 opposite to the third surface 103 of the body 100, and third and fourth coil patterns 313 and 314 may be sequentially disposed on the other surface of the substrate 200 opposite to the fourth surface 104 of the body 100. That is, each of the coil patterns 311, 312, 313, and 314 may be stacked in a width direction (W direction), and may be stacked on opposite surfaces of the substrate 200 with respect to the substrate 200.

First and second insulating layers 410 and 420 to be described below may be disposed between the first and second coil patterns 311 and 312 and between the third and fourth coil patterns 313 and 314, respectively.

Referring to FIGS. 1 and 5, a first lead-out portion 331 may extend from an outermost turn of the second coil pattern 312 and may contact or may be exposed to the sixth surface 106 of the body 100 to be connected to the electrode 500 to be described below. A second lead-out portion 332 may extend from an outermost turn of the fourth coil pattern 314 and may contact or may be exposed to the sixth surface 106 of the body 100 to be connected to a second external electrode 600 to be described below. Here, the first and second lead-out portions 331 and 332 may be disposed to be spaced apart from each other in a longitudinal direction (L direction) on the sixth surface 106 of the body 100. In some embodiments, the first and second lead-out portions 331 and 332 do not contact the sixth surface 106 of the body 100 and the fifth surface 105 (a surface of the body opposing the sixth surface 106).

Referring to FIGS. 2 and 3, the coil portion 300 according to the present example embodiment may include a first via 321 passing through the substrate 200 to connect outer ends of the first coil pattern 311 and the third coil pattern 313 to each other, a second via 322 passing through a first insulating layer 410 to be described below to connect inner ends of the first coil pattern 311 and the second coil pattern 312 to each other, and a third via 323 passing through a second insulating layer 420 to be described below to connect inner ends of the third coil pattern 313 and the fourth coil pattern 314 to each other.

Thus, the coil portion 300 may function as a single coil by the first to fourth coil patterns 311, 312, 313, and 314 connected in series between first and second external electrodes 500 and 600.

Each of the first to fourth coil patterns 311, 312, 313, and 314 may have a planar spiral shape with at least one turn formed with respect to the core 110 of the body 100. In the present example embodiment, a winding axis of each of the coil pattern 311, 312, 313, and 314 may be disposed in parallel with the sixth surface 106 of the body 100.

Referring to FIGS. 1 and 2, the coil portion 300 according to the present example embodiment may further include first and second sub-lead-out portions 341 and 342.

The sub-lead-out portions 341 and 342 may be omitted, but may have an effect of strengthening a bonding force, preventing warpage of the substrate 200, or the like by increasing a contact area between the coil portion 300 and the external electrodes 500 and 600.

The first sub-lead-out portion 341 may be disposed to be spaced apart from the first coil pattern 311 on one surface of the substrate 200, may be covered by the first insulating layer 410, and may be connected to the first external electrode 500. The second sub-lead-out portion 342 may be disposed to be spaced apart from the third coil pattern 313 on the other surface of the substrate 200, may be covered by the second insulating layer 420, and may be connected to the second external electrode 600.

Referring to FIG. 2, the coil portion 300 according to the present example embodiment may further include sub-vias 351 passing through the insulating layers 410 and 420 to connect the lead-out portions 331 and 332 and the sub-lead-out portions 341 and 342 to each other, respectively.

The sub-vias 351 and 352 may be omitted, but may have effects of improving the rigidity of the coil portion 300 through a physical connection between the lead-out portions 331 and 332 and the sub-lead-out portions 341 and 342, and reducing an Rdc caused by an increase in a contact area between the coil portion 300 and the external electrodes 500 and 600 through an electrical connection between the lead-out portions 331 and 332 and the sub-lead-out portions 341 and 342.

The first sub-via 351 may pass through the first insulating layer 410 to connect the first lead-out portion 331 and the first sub-lead-out portion 341 to each other. The second sub-via 352 may pass through the second insulating layer 420 to connect the second lead-out portion 332 and the second sub-lead-out portion 342 to each other.

Referring to FIG. 3, the first via 321 is illustrated as having an hourglass shape, and the second and third vias 322 and 323 are illustrated as having a tapered shape, but are not limited thereto. The vias 321, 322, and 323 and the sub-vias 351 and 352 may have any shape known in the art such as a tapered shape with a diameter gradually decreasing or increasing from one surface to the other surface of the substrate 200 or the insulating layer 410 or 420, and a cylindrical shape with a uniform diameter, an hourglass shape, and the like.

Each of the first to fourth coil patterns 311, 312, 313, and 314, the first to third vias 321, 322, and 323, the first and second lead-out portions 331 and 332, the first and second sub-lead-out portions 341 and 342, and the first and second sub-vias 351 and 352 may be formed of a conductive material such as copper (Cu), aluminum (Al), silver (Ag), tin (Sn), gold (Au), nickel (Ni), lead (Pb), titanium (Ti), molybdenum (Mo), or an alloy thereof, but is not limited thereto.

At least one of the first to fourth coil patterns 311, 312, 313, and 314, the first to third vias 321, 322, and 323, the first and second lead-out portions 331 and 332, the first and second sub-lead-out portions 341 and 342, and the first and second sub-vias 351 and 352 may include at least one conductive layer.

For example, when the fourth coil pattern 314, the third via 323, and the second lead-out portion 332 are formed by a plating process, each of the fourth coil pattern 314, the third via 323, and the second lead-out portion 332 may include a seed layer formed by a vapor deposition process such as electroless plating or sputtering, and an electrolytic plating layer. Here, the electroplating layer may have a single-layer structure or a multilayer structure. The electroplating layer having the multilayer structure may be formed to have a conformal film structure in which one electroplating layer is covered by another electroplating layer, and to have a shape in which another electroplating layer is stacked on only one surface of one electroplating layer. The seed layers of the fourth coil pattern 314, the third via 323, and the second lead-out portion 332 may be integrally formed, and no boundary therebetween may occur, but are not limited thereto. The electroplating layers of the fourth coil pattern 314, the third via 323, and the second lead-out portion 332 may be integrally formed, and no boundary therebetween may occur, but are not limited thereto.

Referring to FIGS. 1 to 3, the coil component 1000 according to the present example embodiment may further include the first insulating layer 410 insulating between the first and second coil patterns 311 and 312, and the second insulating layer 420 insulating the third and fourth coil patterns 313 and 314.

The insulating layers 410 and 420 may be disposed on the substrate 200, and may be formed to cover the first and third coil patterns 311 and 313 on opposite surfaces of the substrate 200, and the first and second sub-lead-out portions 341 and 342.

In FIGS. 1 and 2, the insulating layers 410 and 420 are illustrated as having a plate shape in the same manner as that of the substrate 200 so as to clarify a connection relationship between elements, but are not limited thereto. The insulating layers 410 and 420 according to the present example embodiment may have a shape of covering the first and third coil patterns 311 and 313 disposed on opposite surfaces of the substrate 200, and the first and second sub-lead-out portions 341 and 342.

Referring to FIGS. 2 and 3, the first and third coil patterns 311 and 313 may be formed on opposite surfaces of the substrate 200, and the insulating layers 410 and 420 may be disposed on the opposite surfaces of 200 to cover the first and third coil patterns 311 and 313, respectively. The second and fourth coil patterns 312 and 314 may be formed on the insulating layers 410 and 420, respectively. In addition, the second and fourth coil patterns 312 and 314 may be covered by an insulating layer IF to be described below.

The insulating layers 410 and 420 may be formed of an insulating material including at least one of a thermosetting insulating resin such as an epoxy resin, a thermoplastic insulating resin such as polyimide, and a photosensitive insulating resin, or may be formed of an insulating material in which a reinforcing material such as a glass fiber or an inorganic filler is impregnated with the insulating resin. For example, the insulating layers 410 and 420 may be formed of a film-type insulating material such as prepreg, ABF, PID, or the like, but are not limited thereto. The insulating layers 410 and 420 may be formed by applying a liquid insulating resin, and then curing the liquid insulating resin.

Referring to FIG. 3, the insulating film IF may be disposed between the coil portion 300 and the body 100 to cover the coil portion 300. The insulating layer IF may be formed along surfaces of the substrate 200, the coil portion 300, and the insulating layers 410 and 420.

The insulating layer IF, used to insulate the coil portion 300 from the body 100, may include a known insulating material such as parylene or the like, but is not limited thereto. The insulating film IF may be formed using a vapor deposition process or the like, but is not limited thereto, and may be formed by stacking an insulation film on opposite surfaces of the substrate 200.

Referring to FIGS. 1 to 5, the external electrodes 500 and 600 may be disposed to be spaced apart from each other on the sixth surface 106 of the body 100, and may be connected to the lead-out portions 331 and 332 of the coil portion 300, respectively. Specifically, the first external electrode 500 may be disposed on the sixth surface 106 of the body 100 to be connected in contact with the first lead-out portion 331 of the second coil pattern 312 exposed to or contact the sixth surface 106 of the body 100, and the second external electrode 600 may be disposed on the sixth surface 106 of the body 100 to be connected in contact with the second lead-out portion 332 of the fourth coil pattern 314 exposed to or contact the sixth surface 106 of the body 100.

As described above, in the present example embodiment in which the external electrodes 500 and 600 are formed only on the sixth surface 106 of the body 100 and do not extend to the first to fifth surfaces 101, 102, 103, 104, and 105 of the body 100, a width direction (W direction) or length direction (L direction) of the coil component 1000 may be reduced to correspond to thicknesses of the external electrodes 500 and 600, and thus it may be advantageous for miniaturization and thinning.

In addition, when the coil component 1000 with the same size is assumed, a volume of the body 100 may be increased, thereby having an effect of improving an inductance characteristic according to an increase in an effective volume.

Referring to FIGS. 4 and 5, the external electrodes 500 and 600 according to the present example embodiment may be formed on the sixth surface 106 that is a mounting surface when the coil component 1000 is mounted on a printed circuit board (PCB).

The first and second external electrodes 500 and 600 may be disposed to be spaced apart from each other on the sixth surface 106 of the body 100, and may be connected in contact with the first and second lead-out portions 331 and 332, respectively.

In addition, the first and second external electrodes 500 and 600 may be formed to be respectively spaced apart by a predetermined distance from the side surfaces of the body 100, that is, the first to fourth surfaces 101, 102, 103, and 104 illustrated in FIG. 4.

As described above, in the present example embodiment in which the external electrodes 500 and 600 are disposed on the sixth surface 106 of the body 100 and have a structure of being spaced apart by a distance from the first to fourth surfaces 101, 102, 103, and 104, a probability of a short circuit occurring between adjacent coil components when mounted on a PCB may be reduced, thereby having an effect of being advantageous for integration.

The external electrodes 500 and 600 may be formed to have a thickness range of 0.5 μm to 100 μm, but are not limited thereto. When thicknesses of the external electrodes 500 and 600 are less than 0.5 μm, detachment and peeling may occur when mounted on a PCB. When the thicknesses of the external electrodes 500 and 600 are greater than 100 μm, it may be disadvantageous in thinning a coil component.

The external electrodes 500 and 600 may be formed of a conductive material such as Cu, Al, Ag, Sn, Au, Ni, Pb, Ti, or an alloy thereof, but are not limited thereto.

The external electrodes 500 and 600 may be formed to have a single-layer or multilayer structure. For example, the first external electrode 500 may include a first layer including Ni and a second layer disposed on the first layer and including Sn. Here, each of the first and second layers may be formed by a plating process, but is not limited thereto. For another example, the first external electrode 500 may include a first layer including Cu, a second layer disposed on the first layer and including Ni, and a third layer disposed on the second layer and including Sn. Here, each of the first to third layers may be formed by a plating process, but is not limited thereto. For another example, the first external electrode 500 may include a resin electrode including a conductive powder and a resin, and a plating layer formed by a plating process on the resin electrode.

Although not shown in the present example embodiment, a surface insulating layer 700 to be described below may be formed on a region of a surface of the body 100 excluding regions in which the external electrodes 500 and 600 are formed. The surface insulating layer 700 may function as a plating resist in forming the external electrodes 500 and 600 on the surface of the body 100 through an electroplating process, but is not limited thereto.

In the coil component 1000 according to the present disclosure, the sixth surface 106 of the body 100 on which the external electrodes 500 and 600 are disposed may be mounted on a PCB or the like, and one surface and the other surface with a largest area among surfaces of the substrate 200 may be disposed to be perpendicular to the sixth surface 106 of the body 100. Thus, an area occupied by the coil component 1000 on a mounting surface of the PCB may be minimized, and as a result, a relatively large number of coil components 1000 may be mounted on the PCB having the mounting surface with the same area.

In addition, each of the coil patterns 311, 312, 313, and 314 may be also disposed to have a shape perpendicular to the sixth surface 106 of the body 100, thereby minimizing noise induced to the PCB due to a change in magnetic flux.

In addition, the coil patterns 311, 312, 313, and 314 may be disposed in multiple layers, and may be connected to each other by vias 321, 322, and 323. Thus, inductance may be improved according to an increase in the number of turns, and a degree of freedom in designing the coil portion 300 may be increased.

### Second Example Embodiment

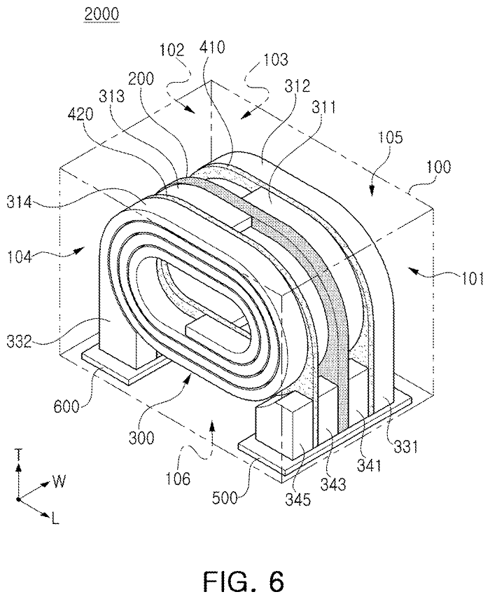

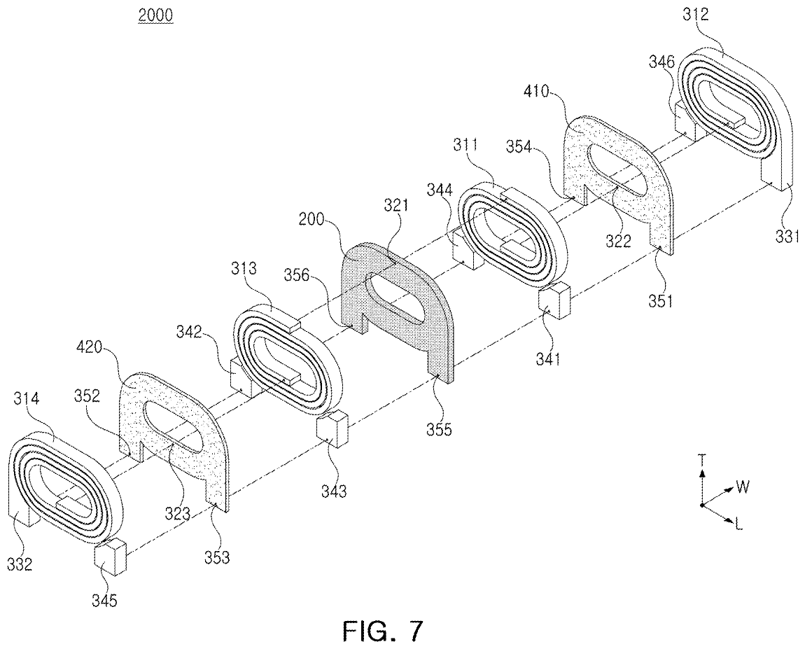

FIG. 6 is a perspective view schematically illustrating a coil component according to a second example embodiment of the present disclosure. FIG. 7, an exploded perspective view of FIG. 6, illustrates a connection relationship of a coil portion.

Referring to FIGS. 1 to 7, a coil component 2000 according to the present example embodiment may be different from the coil component 1000 according to the first example embodiment, in terms of the coil portion 300. Accordingly, in describing the coil component 2000 according to the present example embodiment, only the coil portion 300, different from that in the first example embodiment of the present disclosure, is described. With respect to the other elements of the present example embodiment, the description of the first example embodiment of the present disclosure may be applied in the same or a similar manner.

Referring to FIGS. 6 and 7, the coil portion 300 according to the present example embodiment may further include third to sixth sub-lead-out portions 343, 344, 345, and 346. Some of the third to sixth sub-lead-out portions 343, 344, 345, and 346 may be omitted.

Specifically, the coil portion 300 according to the present example embodiment may further include a third sub-lead-out portion 343 disposed to be spaced apart from the third coil pattern 313 on the other surface (rear surface) of the substrate 200, covered by the second insulating layer 420, and connected to the first electrode 500. In addition, the coil portion 300 may further include a fourth sub-lead-out portion 344 disposed to be spaced apart from the first coil pattern 311 on one surface (front surface) of the substrate 200, covered by the first insulating layer 410, and connected to the second external electrode 600.

In addition, the coil portion 300 according to the present example embodiment may further include a fifth sub-lead-out portion 345 disposed on the second insulating layer 420 to be spaced apart from the fourth coil pattern 314 and connected to the first external electrode 500. In addition, the coil portion 300 may further include a sixth sub-leading portion 346 disposed on the first insulating layer 410 to be spaced apart from the second coil pattern 312 and connected to the second external electrode 600.

Referring to FIG. 7, in the present example embodiment, connections between the first, third, and fifth sub-lead-out portions 341, 343, and 345 may be performed through the third and fifth sub-vias 353 and 355, and connections between the second, fourth, and sixth sub-lead-out portions 342, 344, and 346 may be performed through the fourth and sixth sub-vias 354 and 356, but are not limited thereto.

Specifically, the coil portion 300 according to the present example embodiment may further include a third sub-via 353 passing through the second insulating layer 420 to connect the third and fifth sub-lead-out portions 343 and 345 to each other, and a fourth sub-via 354 passing through the first insulating layer 410 to connect the fourth and sixth sub-lead-out portions 344 and 346 to each other. In addition, the coil portion 300 may further include a fifth sub-via 355 passing through the substrate 200 to connect the first and third sub-lead-out portions 341 and 343, and a sixth sub-via 356 passing through the substrate 200 to connect the second and fourth sub-lead-out portions 342 and 344 to each other.

Each of the sub-lead-out portions 341 to 346 may be formed through the same process as that of the coil patterns 311 to 314, and may have substantially the same thickness as those of the coil patterns 311 to 314 (a size in a W direction based on a direction of FIG. 7), but is not limited thereto.

In the present example embodiment, the coil portion 300 may further include the third to sixth sub-lead-out portions 343, 344, 345, and 346, and thus a contact area between the coil portion 300 and the external electrodes 500 and 600 may be increased, thereby improving a bonding force therebetween.

In addition, the sub-vias 351 to 356 passing through the substrate 200 or the insulating layers 410 and 420 may perform an electrical connection, thereby having an effect of reducing an Rdc when an area in contact with the external electrodes 500 and 600 increases.

In addition, the lead-out portions may be disposed to have a symmetrical shape in a width direction (W direction) and a length direction (L direction), thereby improving an issue related to warpage of the substrate 200.

### Third Example Embodiment

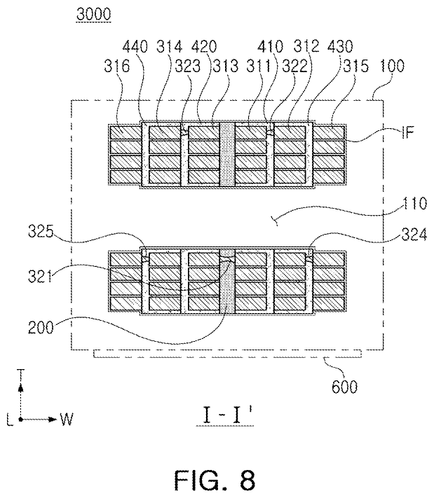

FIG. 8, a cross-sectional view of a coil component according to a third example embodiment of the present disclosure, corresponds to FIG. 3.

Referring to FIGS. 1 to 8, a coil component 3000 according to the present example embodiment may be different from the coil components 1000 and 2000 according to the first and second example embodiments of the present disclosure, in terms of the coil portion 300 and the insulating layers 410, 420, 430, and 440. Accordingly, in describing the coil component 3000 according to the present example embodiment, only the coil portion 300 and the insulating layers 410, 420, 430, and 440, which are different from those in the first and second example embodiments of the present disclosure, are described. With respect to the other elements of the present example embodiment, the description of the first example embodiment and/or the second example embodiment of the present disclosure may be applied in the same or a similar manner.

Referring to FIG. 8, in the coil portion 300, coil patterns 311 to 316 formed in three layers may be disposed on each of opposite surfaces of the substrate 200. That is, when compared to the coil components 1000 and 2000 according to the first and second example embodiments of the present disclosure, the third and fourth insulating layers 430 and 440, the fifth and sixth coil patterns 315 and 316, and the fourth and fifth vias 324 and 325 may be further included.

Specifically, the third insulating layer may be disposed on the first insulating layer 410 to cover the second coil pattern 312, and the fourth insulating layer 440 may be disposed on the second insulating layer 420 to cover the fourth coil pattern 314.

In addition, the fifth coil pattern 315 may be disposed on the third insulating layer 430, and the sixth coil pattern 316 may be disposed on the fourth insulating layer 440.

The fourth via 324 may pass through the third insulating layer 430 to connect the second and fifth coil patterns 312 and 315 to each other. In addition, the fifth via 325 may pass through the fourth insulating layer 440 to connect the fourth and sixth coil patterns 314 and 316 to each other.

Referring to FIG. 8, in the coil component 3000 according to the present example embodiment, coil patterns 315 and 316 may be respectively added as one layer to opposite surfaces of the substrate 200, and accordingly an arrangement of the vias 321 to 325 connecting the lead-out portions 331 and 332 and the coil patterns 311 to 316 may be different from those in the coil components 1000 and 2000 according to the first and second example embodiments.

Specifically, the first via 321 may pass through the substrate 200 to connect inner ends of the first and third coil patterns 311 and 313 to each other.

In addition, the second via 322 may pass through the first insulating layer 410 to connect outer ends of the first and second coil patterns 311 and 312 to each other, and the third via 323 may pass through the second insulating layer to connect outer ends of the third and fourth coil patterns 313 and 314 to each other.

In addition, the fourth via 324 may pass through the third insulating layer 430 to connect inner ends of the second and fifth coil patterns 312 and 315 to each other, and the fifth via 325 may pass through the fourth insulating layer 440 to connect the fourth and sixth coil patterns 314 and 316 to each other.

In the present example embodiment, the coil patterns 315 and 316 may be respectively added as one layer to opposite surfaces of the substrate 200, and accordingly the total number of turns of the coil may increase, and inductance may increase to achieve a high-capacity coil component.

In the present example embodiment, the coil portion 300 may be further formed as one layer on each of opposite surfaces of the substrate 200. Thus, when it is assumed that the coil portion 300 is disposed in the body 100 with the same size, each of the coil patterns 311 to 316 may be formed to have a smaller distance (thickness) from one surface to the other surface than that of the coil pattern in the above-described example embodiments.

In this case, each of the coil patterns 311 to 316 may have a relatively low aspect ratio (AR), and thus may be formed to have an overall flat coil shape, thereby reducing a defect rate and minimizing costs, when a coil pattern layer is formed.

### Fourth Example Embodiment

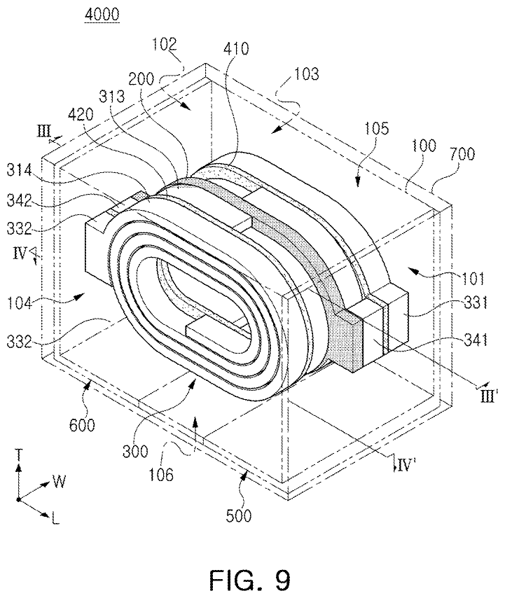

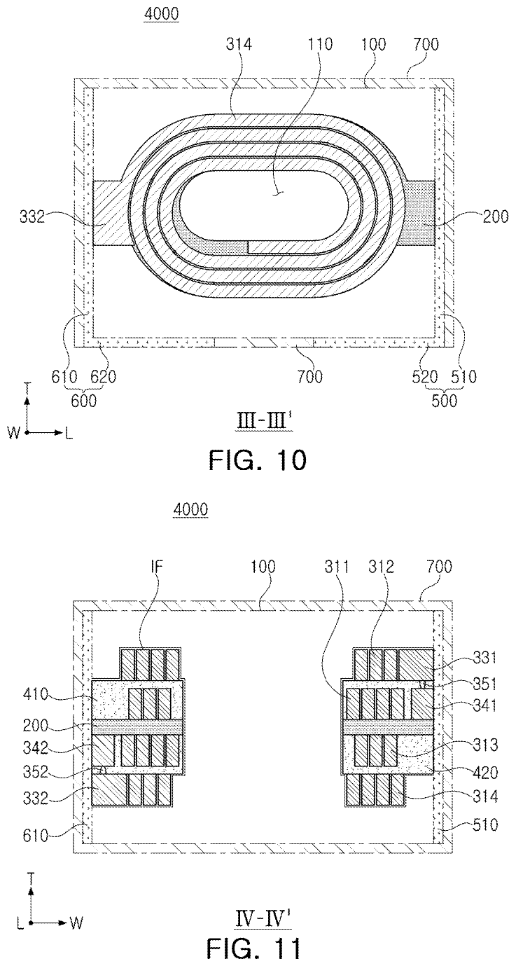

FIG. 9 is a perspective view schematically illustrating a coil component according to a fourth example embodiment of the present disclosure. FIG. 10 is a view illustrating a cross-section taken along line of FIG. 9. FIG. 11 is a view illustrating a cross-section taken along line IV-IV′ of FIG. 9.

Referring to FIGS. 1 to 11, a coil component 4000 according to the present example embodiment may be different from the coil components 1000, 2000, and 3000 according to the first to third example embodiments of the present disclosure, in terms of the coil portion 300 and the external electrodes 500 and 600. In addition, the surface insulating layer 700 covering portions of the external electrodes 500 and 600 may be further included. Accordingly, in describing the present example embodiment, only the coil portion 300, the external electrodes 500 and 600, and the surface insulating layer 700, which are different from those in the first to third example embodiments of the present disclosure, are described. With respect to the other elements of the present example embodiment, the descriptions of the first to third example embodiments of the present disclosure may be applied in the same or a similar manner.

Referring to FIGS. 9 to 11, the first and second lead-out portions 331 and 332 of the coil component according to the present example embodiment may be respectively exposed to or contact opposite end surfaces of the body 100, that is, the first surface 101 and the second surface 102, to be connected to the first and second external electrodes 500 and 600. In addition, the first and second lead-out portions 331 and 332 may be disposed to be spaced apart from the sixth surface 106 of the body 100.

In the present example embodiment, the external electrodes 500 and 600 may be disposed on the first surface 101 and the second surface 102 of the body 100, and may extend to the sixth surface 106 of the body 100, unlike those in the above-described example embodiments.

Referring to FIG. 10, the external electrodes 500 and 600 may include connection portions 510 and 520 connected to the coil portion 300, and pad portions 520 and 620 respectively disposed on mounting surfaces thereof.

Specifically, the first external electrode 500 may include a first connection portion 510 connected to the first lead-out portion 331 on one end surface of the body 100, that is, the first surface 101, and a first pad portion 520 extending from the first connection portion 510 to be disposed on one surface of the body 100, that is, the sixth surface 106. In addition, the second external electrode 600 may include a second connection portion 610 connected to the second lead-out portion 332 on the other end surface of the body 100, that is, the second surface 102, and a second pad portion 620 extending from the second connection portion 610 to be disposed on the one surface of the body 100, that is, the sixth surface 106.

Referring to FIGS. 9 to 11, the coil component 4000 according to the present example embodiment may further include the surface insulating layer 700 disposed on the body 100, covering the first and second connection portions 510 and 610, and exposing the first and second pads portions 520 and 620.

The surface insulating layer 700 may cover regions of the first to sixth surfaces 101 to 106 of the body 100 excluding regions in which the pad portions 520 and 620 of the external electrodes 500 and 600 are formed. That is, the surface insulating layer 700 may be disposed not only on a surface of the body 100, but also on the connection portions 510 and 610, thereby exposing the external electrodes 500 and 600 only to a mounting surface in a direction of the sixth surface 106 of the body 100.

Through such a structure, in the present example embodiment, the external electrodes 500 and 600 may be exposed only to or contact the mounting surface regardless of lead-out positions of the lead-out portions 331 and 332, and a risk of a short circuit between adjacent coil components 4000 may be reduced without a structural change of the coil portion 300.

The surface insulating layer 700 may function as a plating resist in forming the external electrodes 500 and 600 by a plating process, but is not limited thereto.

The surface insulating layer 700 may include a thermoplastic resin such as a polystyrene resin, a vinyl acetate resin, a polyester resin, a polyethylene resin, a polypropylene resin, a polyamide resin, a rubber resin, an acrylic resin, or the like, a thermosetting resin such as a phenolic resin, an epoxy resin, a urethane resin, a melamine resin, an alkyd resin, or the like, a photosensitive resin, parylene, SiOₓ, or SiNₓ.

The surface insulating layer 700 may have an adhesive function. For example, when the surface insulating layer 700 is formed of an insulating film, the insulating film may include an adhesive component to be adhered to a surface of the body 100. In this case, an adhesive layer may be additionally formed on one surface of the surface insulating layer 700. However, in the same manner as a case of forming the surface insulating layer 700 using an insulating film that is in a semi-cured state (B-stage), the adhesive layer may not be additionally formed on the one surface of the surface insulating layer 700.

The surface insulating layer 700 may be formed by applying a liquid insulating resin to a surface of the body 100, stacking an insulating film on the surface of the body 100, or forming an insulating resin on the surface of the body 100 by a vapor deposition process. In the case of the insulating film, a dry film (DF) including a photosensitive insulating resin, an ABF not including the photosensitive insulating resin, or a polyimide film may be used.

A total thickness of the surface insulating layer 700 may be formed to have a range of 10 nm to 100 μm. When the thickness of the surface insulating layer 700 is less than 10 nm, characteristics of a coil component may be reduced, such as a reduction in Q factor, breakdown voltage reduction, and self-resonant frequency (SRF) reduction. When the thickness of the surface insulating layer 700 is greater than 100 μm, a total length, width, and thickness of the coil component may increase, and thus it may be disadvantageous in thinning.

While example embodiments have been shown and described above, it will be apparent to those skilled in the art that modifications and variations could be made without departing from the scope of the present disclosure as defined by the appended claims.

What is claimed is:

1. A coil component comprising:
a body having one surface and the other surface facing each other, and a plurality of side surfaces connecting the one surface and the other surface to each other;
a substrate disposed in the body;
a coil portion including:
first and second coil patterns disposed on one surface of the substrate and each having at least one turn, and
third and fourth coil patterns disposed on the other surface of the substrate and each having at least one turn; and
first and second external electrodes disposed on the one surface of the body, spaced apart from each other and from the plurality of side surfaces, and connected to the second and fourth coil patterns, respectively,
wherein winding axes of the first to fourth coil patterns are parallel to the one surface of the body.

2. The coil component of claim 1, further comprising:
a first insulating layer disposed between the first and second coil patterns to cover the first coil pattern; and
a second insulating layer disposed between the third and fourth coil patterns to cover the third coil pattern.

3. The coil component of claim 1, wherein the coil portion further includes:
a first lead-out portion extending from an outermost turn of the second coil pattern to contact the one surface of the body; and
a second lead-out portion extending from an outermost turn of the fourth coil pattern to contact the one surface of the body.

4. The coil component of claim 2, wherein the coil portion further includes:
a first via passing through the substrate to connect outer ends of the first and third coil patterns to each other;
a second via passing through the first insulating layer to connect inner ends of the first and second coil patterns to each other; and
a third via passing through the second insulating layer to connect inner ends of the third and fourth coil patterns to each other.

5. The coil component of claim 2, further comprising:
an insulating film integrally covering surfaces of the substrate, the coil portion, and the first and second insulating layers.

6. The coil component of claim 2, wherein the coil portion further includes:
a first sub-lead-out portion disposed on the one surface of the substrate, spaced apart from the first coil pattern, covered by the first insulating layer, and connected to the first external electrode; and
a second sub-lead-out portion disposed on the other surface of the substrate, spaced apart from the third coil pattern, covered by the second insulating layer, and connected to the second external electrode.

7. The coil component of claim 6, wherein the coil portion further includes:
a first sub-via passing through the first insulating layer to connect the first lead-out portion and the first sub-lead-out portion to each other; and
a second sub-via passing through the second insulating layer to connect the second lead-out portion and the second sub-lead-out portion to each other.

8. The coil component of claim 6, wherein the coil portion further includes:
a third sub-lead-out portion disposed on the other surface of the substrate, spaced apart from the third coil pattern, covered by the second insulating layer, and connected to the first external electrode; and
a fourth sub-lead-out portion disposed on the one surface of the substrate, spaced apart from the first coil pattern, covered by the first insulating layer, and connected to the second external electrode.

9. The coil component of claim 8, wherein the coil portion further includes:
a fifth sub-lead-out portion disposed on the second insulating layer, spaced apart from the fourth coil pattern, and connected to the first external electrode; and
a sixth sub-lead-out portion disposed on the first insulating layer, spaced apart from the second coil pattern, and connected to the second external electrode.

10. The coil component of claim 9, wherein the coil portion further includes:
a third sub-via passing through the second insulating layer to connect the third and fifth sub-lead-out portions to each other;
a fourth sub-via passing through the first insulating layer to connect the fourth and sixth sub-lead-out portions to each other;
a fifth sub-via passing through the substrate to connect the first and third sub-lead-out portions to each other; and
a sixth sub-via passing through the substrate to connect the second and fourth sub-lead-out portions to each other.

11. The coil component of claim 2, further comprising:
a third insulating layer disposed on the first insulating layer, and covering the second coil pattern, and
a fourth insulating layer disposed on the second insulating layer, and covering the fourth coil pattern,
wherein the coil portion further includes:
a fifth coil pattern disposed on the third insulating layer; and
a sixth coil pattern disposed on the fourth insulating layer.

12. The coil component of claim 11, wherein the coil portion further includes:
a first via passing through the substrate, and connecting inner ends of the first and third coil patterns;
a second via passing through the first insulating layer to connect outer ends of the first and second coil patterns to each other;
a third via passing through the second insulating layer to connect outer ends of the third and fourth coil patterns to each other:
a fourth via passing through the third insulating layer to connect inner ends of the second and fifth coil patterns to each other; and
a fifth via passing through the fourth insulating layer to connect inner ends of the fourth and sixth coil patterns to each other.

13. A coil component comprising:
a body having one surface, and one end surface and the other end surface connected to the one surface and facing each other;
a substrate disposed in the body;
a coil portion including:
first and second coil patterns disposed on one surface of the substrate and each having at least one turn,
third and fourth coil patterns disposed on the other surface of the substrate and each having at least one turn, and
first and second lead-out portions in contact with the one end surface and the other end surface of the body, respectively, and spaced apart from the one surface of the body; and
first and second external electrodes disposed on the one end surface and the other end surface of the body, respectively, to be connected to the first and second lead-out portions, respectively,
wherein winding axes of the first to fourth coil patterns are parallel to the one surface of the body.

14. The coil component of claim 13, wherein
the first lead-out portion extends from an outermost turn of the second coil pattern to contact the one end surface of the body, and the second lead-out portion extends from an outermost turn of the fourth coil pattern to contact the other end surface of the body,
the first external electrode includes:
a first connection portion connected to the first lead-out portion on the one end surface of the body, and
a first pad portion extending from the first connection portion to be disposed on the one surface of the body, and
the second external electrode includes:
a second connection portion connected to the second lead-out portion on the other end surface of the body, and
a second pad portion extending from the second connection portion to be disposed on the one surface of the body.

15. The coil component of claim 14, further comprising:
a surface insulating layer disposed on the body, covering the first and second connection portions, and exposing the first and second pad portions.

16. The coil component of claim 13, wherein the first and second lead-out portions do not contact the one surface of the body and a surface of the body opposing the one surface.

17. A coil component comprising:
a body having one surface and the other surface facing each other, and a plurality of side surfaces connecting the one surface and the other surface to each other;
a substrate disposed in the body and having one surface facing one of the plurality of side surfaces;
a coil portion including:
first and second coil patterns disposed on the one surface of the substrate and each having at least one turn, and
third and fourth coil patterns disposed on the other surface of the substrate and each having at least one turn; and
first and second external electrodes disposed on the one surface of the body, spaced apart from each other and from the plurality of side surfaces, and connected to the second and fourth coil patterns, respectively.

18. The coil component of claim 17, further comprising:
a first insulating layer disposed between the first and second coil patterns to cover the first coil pattern; and
a second insulating layer disposed between the third and fourth coil patterns to cover the third coil pattern.

19. The coil component of claim 18, wherein the coil portion further includes:
a first sub-lead-out portion disposed on the one surface of the substrate, spaced apart from the first coil pattern, covered by the first insulating layer, and connected to the first external electrode; and
a second sub-lead-out portion disposed on the other surface of the substrate, spaced apart from the third coil pattern, covered by the second insulating layer, and connected to the second external electrode.
